(19) United States
(12) Patent Application Publication
(10) Pub. No.: US 2014/0218795 A1
(43) Pub. Date: Aug. 7, 2014

(54) POWER SCALABLE MULTI-PASS FARADAY ROTATOR

(71) Applicant: Electro-Optics Technology, Inc., Traverse City, MI (US)

(72) Inventor: David Scerbak, Traverse City, MI (US)

(73) Assignee: ELECTRO-OPTICS TECHNOLOGY, INC., Traverse City, MI (US)

(21) Appl. No.: 14/167,695

(22) Filed: Jan. 29, 2014

Related U.S. Application Data
(60) Provisional application No. 61/761,078, filed on Feb. 5, 2013.

(51) Int. Cl. G02F 1/09

(52) U.S. Cl. CPC G02F 1/093
USPC 359/484.04

(57) ABSTRACT

Transparent heat-conductive layers of significant thickness are bonded or adhered to opposing optical faces of a Faraday optic to form a Faraday optic structure that can be used with beam-folding mirrors and an external magnetic field to form a multi-pass Faraday rotator with minimal thermal gradient across the beam within the Faraday optic. The transparent heat conductive layers conduct heat through the Faraday optic substantially parallel to the beam propagation axis for each pass through the Faraday optic structure and thereby reduce thermal gradients across the beam cross section that would otherwise contribute to thermal lens focal shifts and thermal birefringence in the Faraday optic structure. The multi-pass Faraday rotator of this invention is suitable for use with any device based upon the Faraday effect such as optical isolators, optical circulators and Faraday mirrors that are scalable with beam size to power levels in excess of 2 kW.

### CROSS-REFERENCES TO RELATED APPLICATIONS

This application claims benefit under 35 U.S.C. §119 to U.S. Provisional Patent Application Ser. No. 61/761,078 filed Feb. 5, 2013, which is incorporated herein for all purposes.

### STATEMENT AS TO RIGHTS TO INVENTIONS MADE UNDER FEDERALLY SPONSORED RESEARCH AND DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

### BACKGROUND OF THE INVENTION

This invention relates generally to power scalable Faraday rotators for use in Faraday effect devices such as optical isolators with lasers that have optical power up to, and in excess of, 2 kW. The Faraday rotator of this invention preserves the beam quality of high brightness lasers by substantially eliminating thermal lens focal shifts and thermal birefringence.

Historically kW class lasers such as CO₂, diode arrays and flashlamp pumped Nd:YAG lasers have been highly multi-mode. The relative low brightness of these lasers has made them essentially insensitive to all but the most reflective targets. Unlike multi-mode lasers, single mode lasers are typically highly sensitive to reflections. High gain fiber lasers are extremely sensitive to feedback—particularly when the most user flexible master oscillator—power amplifier (“MOPA”) architecture is used. As direct diode arrays continue their progression towards diffraction limited performance they too have demonstrated the expected increased sensitivity to reflections from practical targets. High power waveguide CO₂ lasers are a final example of lasers which have evolved from historical designs which were low brightness and largely feedback insensitive, to high brightness efficient laser sources that are now sensitive to feedback from reflective work surfaces. Single mode kW fiber lasers are revolutionizing industrial metalworking with their unprecedented brightness. The brightness of these lasers coupled with fiber optic delivery makes them very attractive sources when mounted to robotic arms that can cut, weld and drill metal at previously unattainable rates—and do so remotely from large working distances. Following just behind fiber lasers are rapid advances in high power direct diode arrays. Direct diode arrays offer the potential for even greater efficiency and simplicity than fiber lasers for many applications. Recently, tremendous progress have been made in direct diode laser arrays regarding improved mode quality. They now have sufficient brightness to achieve “keyhole” deep penetration welding in thick metal—a practical milestone of great significance. Finally, waveguide CO₂ lasers are revitalizing CO₂ laser applications with near diffraction limited performance and new applications (e.g. EUV generation).

Optical isolators are optical components used to de-couple laser sources from backward propagating radiation such as from reflections or amplifier noise emission. They are commonly used components for laser systems of 100 W average power or less and have been available for higher powers on a custom product basis. The rapid emergence of high power single mode fiber lasers, high brightness direct diode arrays and waveguide CO₂ lasers as industrial workplace tools for cutting, welding and drilling reflective metals has created an urgent need for high performance kW class optical isolators at a low cost. Highly reflective molten metal pools created with these high power lasers can couple radiation back into laser sources with high efficiency—even when working at non-normal incidence angle. Radiation feedback from reflections is well known to cause power instabilities in single and low order mode lasers or even lead to catastrophic optical damage. For these reasons, practical optical isolators to protect and preserve the performance of new kW class lasers are now urgently required.

A typical polarization maintaining [“PM”] broadband optical isolator of the prior art is shown in FIG. 1. The Faraday rotator 6 shown within the dashed lines is comprised of a cylindrical rod shaped Faraday rotation optic 4 and permanent magnets 5. The magnets 5 generate a magnetic field parallel to the radiation axis 1 from the laser source 2 that causes the plane of linear polarization to rotate as it passes through a Faraday optic 4. By Faraday optic, it is meant an optically transmissive material that rotates the plane of polarized light about the axis of propagation in the presence of an axial magnetic field. Typically a Faraday optic is a solid slab, sheet or cylinder such as terbium gallium garnet (TGG) with opposing polished flat faces through which an optical beam or beams can be directed. Alternatively a Faraday optic may be a suitable material grown or deposited on a polished transmissive surface or substrate that might be first polished, then juxtaposed and bonded or adhered to a facing like material on an opposing similar surface or substrate. The magnetic field strength 5 and length of the Faraday optic 4 are selected in a typical Faraday rotator 6 to give 45° polarization rotation at the selected design laser wavelength. Although higher fields are possible with larger structures, size and cost considerations regarding expensive rare-earth permanent magnets 5 limit the average magnetic field to about 10.3 kGauss over the relatively long 2 cm Faraday optic length typical of TGG Faraday rotators at 1064 nm. Faraday rotation is non-reciprocal meaning that the sense of rotation when viewed from the direction of forward propagation is the same for beams propagating through the Faraday rotator in either direction. This is in contrast to reciprocal polarization rotation such as in waveplates and quartz rotators where the sense of rotation when viewed from the forward propagation direction changes for beams passing through the reciprocal rotator in either direction. In FIG. 1, the polarization rotation from Faraday rotator 6 serves to rotate the polarization 45° from a first input polarizer 3. Quartz optical rotator 7 adds an additional 45° for a total of 90° linear polarization in the transmission direction onto the transmission axis of a second output polarizer 8 on the opposite end of the Faraday rotator. Backward propagating radiation transmitted through the second output polarizer 8, reciprocal quartz rotator 7 and the Faraday rotator 6 towards the laser source 2 is orthogonally polarized to the first polarizer 3 and thereby rejected 9.

At wavelength λ and temperature T the angle of polarization rotation, θ, in a Faraday rotator is given by:

θ(λ,T)=V(λ,T)·L·H(T) eqn. 1

where H(T) is the magnetic field in the direction of beam propagation, L is the length of the Faraday optic in this direction and V(λ,T) is the Verdet constant of the Faraday optic. The prior art optical isolator of FIG. 1 also includes a transmissive optical quartz rotator 7 which has similar polarization rotation dispersion to compensate for the wavelength dependence of the Faraday optic 4 Verdet constant for broadband operation of the prior art FIG. 1 optical isolator as is generally known in the art [P. A. Schulz “Wavelength independent Faraday isolator”, Appl. Opt. 28, 4458-4464 (1989)].

Multi-pass forms of Faraday rotators and optical isolators have been disclosed with the intent of reducing the overall size and cost of these devices. U.S. Pat. No. 4,909,612 (Scerbak et. al.) disclosed a multi-pass optical isolator based upon a slab of Faraday rotator medium with input and output windows and reflective internal surfaces to form a zig-zag (multi-pass) path through the Faraday rotator. This patent also disclosed a strong magnet structure that used 4 block shaped magnets. However the magnetic fields of this device were not uniform and the desired high optical isolation could only be achieved with very small beams. U.S. Pat. No. 5,715,080 (Scerbak) disclosed many different multi-pass optical isolator forms that benefitted from an improved magnet geometry with greatly improved field uniformity to support large beam cross sections. U.S. Pat. No. 7,057,791 (Azimi et. al.) also teaches many similar structures. The multi-pass prior art can be exemplified by FIGS. 8a-c which are direct copies of FIG. 8, FIG. 11 and FIG. 19, respectively, from U.S. Pat. No. 5,715,080. FIG. 8a and FIG. 8b can be discussed together since FIG. 8b is a cross sectional view of FIG. 8a along the line labeled 9-9. In FIG. 8a a beam of radiation A is input into optical isolator 83 through input polarizer 59. The beam then propagates through an anti-reflection coating 88 deposited onto polished optical surface of Faraday optic 85 and then makes a multi-pass pathway of 7 total passes of Faraday optic 85 due to reflective coatings 90 and 93 deposited onto the front 89 and rear 91 polished surfaces of Faraday optic 85. Finally, the beam exits the optical isolator through wave-plate 70 and output polarizer 69. The lower, non-optical surface of Faraday optic 85 is mounted to, and conductively cooled by, “V” shaped aluminum mount 94 in FIG. 8b. Screw 55 adjusts the gap 80 between magnets 95 to adjust the magnetic field strength to achieve the desired 45° of Faraday rotation. FIG. 8c is similar and serves to show how an even number of passes can also be made through such a compact multi-pass Faraday rotator used in an optical isolator. To date, optical isolators suitable for use with high power lasers have suffered from thermal effects within the isolator optical elements. Intrinsic absorption of laser radiation transmitted through bulk optical elements and coatings within an optical isolator cause a thermal gradient to occur across the beams spatial profile. Faraday rotator materials typically have a higher absorption coefficient than any other element within an optical isolator. Heat removal from the non-optical surfaces of the cylindrical Faraday rotator rod 4 within the Faraday rotator 6 of FIG. 1 results in a significant thermal gradient across the laser beam profile at high power. Because the Verdet constant V(λ,T) is a function of temperature, this thermal gradient will cause the polarization rotation θ(λ,T) to vary across the beam profile. However, this thermal profile is also responsible for two more serious and detrimental thermal effects in a high power Faraday rotator: thermal lensing and thermal birefringence.

Depending upon the specific requirements of a given application, thermal lensing in optical isolators can be of a concern with as little as 20 W of average optical power. Thermal lensing primarily results from a change in the materials refractive index with temperature [dn/dT] that is present within optical components. Stress birefringence and end effects also contribute to the thermal lens, however, since their contribution is small they are usually ignored [W. M. Koechner, Solid State Laser Engineering, 2nd ed. (Springer, Heidelberg, 1988), pp. 51, 359.] The focal length of a thermal lens in a Faraday rotator scales as the square of beam radius. For this reason, past attempts to reduce the thermal lens focal length have used large beams in very large and expensive Faraday rotators. However, because thermal lensing does vary the beam parameters of a laser beam, it is most importantly, and practically, observed as a shift in the focal position of the optical system, ΔZ_{TL}, which focuses the laser beam. When expressed relative to the Rayleigh range Z_{R} of the focused spot, the relative thermal lens focal shift ΔZ_{TL}/Z_{R}, has been demonstrated to be independent of beam diameter for a given Faraday rotator material and linearly dependent upon average optical power [K. Nicklaus and T. Langer, “Faraday isolators for high average power fundamental mode radiation”, Proc. of SPIE Vol. 7578, (2010)]. For average power P in kW, and focused spot Rayleigh range Z_{R}, the relative thermal lens focal shift for a diffraction limited beam is:

Δz_{TL}/z_{R}=ALP eqn. 2

For a fixed wavelength, A in eqn. 2 is a constant that has proportional units of kW⁻¹ cm⁻¹ and is derived from measurable constants such as the thermo-optical coefficient (dn/dT), absorption coefficient and thermal conductivity. The length L of the optical material is expressed in cm.

The Rayleigh range Z_{R} associated with a given waist radius ωo at wavelength λ is:

$${z}_{R} = \frac{{πω}_{o}^{2}}{λ} \qquad eqn . 3$$

Assuming relative focal shifts ΔZ_{TL}/Z_{R} that are small relative to the focal length of a final focusing lens, it is straightforward to approximate how the focused beam radius ω(ΔZ_{TL}) will increase at higher power, P, from a starting condition where the low power waist ωₒ is in the focal plane of the final focusing lens:

$$ω ( Δ {z}_{TL} ) = {{ω}_{o} [ 1 + {( \frac{Δ {z}_{TL}}{{Z}_{R}} )}^{2} ]}^{1 / 2} \qquad eqn . 4$$

For a common high power Faraday rotator material such as terbium gallium garnet [“TGG”], the characteristic constant is typically found to be A≈4 cm⁻¹kW⁻¹ at 1064 nm when the TGG is of high quality with absorption coefficient α=0.0015 cm⁻¹. For a beam of any diameter and power P (in kW) at 1060 nm, the relative focal shift is therefore ΔZ_{TL}/Z_{R}≈−8P when using 2 cm of high quality TGG with a single diffraction limited beam in a polarization maintaining [“PM”] optical isolator. High power fiber lasers are typically randomly polarized and are isolated with polarization insensitive [“PI”] optical isolators which resolve the random fiber laser polarization into two physically separated beams of power P/2 through the Faraday rotator of the optical isolator—thereby reducing the total ΔZ_{TL}/Z_{R} by a factor of 2. For an application such as laser additive machining (“LAM”) where it is necessary to have a very tight focus at low power, but where it is also important to vary the laser power rapidly, the effects of thermal lensing can be readily seen to be very important. For example, for a diffraction limited collimated 1060 nm randomly polarized fiber laser beam 1/e² diameter of 10 mm into a final focusing lens of 500 mm fl, the low power focused beam radius, ωₒ, according to diffractive theory will be 33.7 μm with a corresponding Rayleigh range Z_{R}=3.37 mm. In this case if the final focusing lens of a LAM system is positioned to focus the laser beam tightly at low power for sintering metal powder into small, fine features, according to eqns 3 & 4 the beam diameter at a total randomly polarized fiber laser power P=1 kW will be:

$${\begin{matrix}ω ( Δ {z}_{TL} ) = 33.7 μm [ 1 + {( \frac{4 {z}_{R}}{{z}_{R}} )}^{2} ] \\ = 139 μm\end{matrix}}^{1 / 2}$$

Such large differences in focused beam radius can manifest themselves as visually noticeable changes in the feature size as well as measurable dimensional shifts in LAM fabricated parts. A Faraday rotator having low focal shifts due to thermal lensing with rapidly changing high power levels is therefore desired.

The other detrimental thermal effect occurring in high power Faraday rotators noted previously is thermal birefringence. The thermal gradient across the beam profile due to absorption leads to thermal strains in the optical isolator components at high power due to insufficient thermal conductivity in the isolator components, the physical result of insufficient thermal conductivity and bulk. These thermal strains cause linear birefringence via the photoelastic effect—primarily in the Faraday rotator optic since overall device absorption is typically dominated by this isolator element. Thermal birefringence can exceed polarizer extinction as the limiting factor determining the isolation ratio, and consequently effectiveness, of an optical isolator at high power. Thermal birefringence scales with the square of each of the following incident parameters: incident power level P, Faraday optic length L and absorption coefficient a. Unlike the focal length of a thermal lense, thermal birefringence is independent of beam size. For a TGG rod length of 1.6 cm and absorption coefficient of α≈0.002 cm-1, it has been shown that thermal birefringence will limit isolation to less than 25 dB with less than 200 W [K. Nicklaus and T. Langer, “Faraday isolators for high average power fundamental mode radiation”, Proc. of SPIE Vol. 7578, (2010)]. At increasing power levels, isolation drops rapidly unless thermal birefringence is addressed in the optical isolator. A Faraday rotator having low thermal birefringence at high power is therefore desired.

Active thermal lens focal shift compensation via physical lens translation can be considered as a viable means for reducing the effects of thermal lensing in optical isolators. However, a compact, robust, inexpensive means for accurately sensing thermal lens focal length shifts to feedback into an active thermal lens compensation system is a difficult design task. Additionally, the need for sub-Hz response times for rapid power changes while simultaneously precisely maintaining the original beam path is presently challenging, bulky and costly—although future innovation may address these issues. In any event, active thermal lens focal shift compensation does not address thermal birefringence effects in a Faraday rotator.

All-fiber optical isolators may have the potential to resolve the thermal issues noted above for high power optical isolators. All fiber optical isolators are comprised of Faraday fiber (in a magnetic field) spliced to polarizing fiber. Like fiber lasers, all-fiber isolators should, in principle, have beam parameters defined by the fiber waveguide characteristics. As a consequence, thermal lensing would not be expected from all-fiber isolators if the Faraday fiber and polarizing fiber which are fusion spliced together in such devices can be made to handle high power. Recently, all-fiber optical isolators of small size using short terbium glass based fiber have become available commercially for power levels up to 5 W only (AdValue Photonics Inc., 3708 E. Columbia Street, Suite 100, Tucson, Ariz. 85714. Model #AP-AFI-1060PM). Some work has been done to try to incorporate the small Faraday rotation present in low loss silica fiber into practical all-fiber optical isolators (Gerald T. Moore, “In-fiber optical isolator for high-power operation”, U.S. Pat. No. 7,336,858 B1, Feb. 26, 2008) . These research efforts however have been plagued by very large, heavy and expensive magnet structures that do not seem suitable for widespread commercial use. It remains to be seen if high rotation Faraday fiber can be made with low enough loss to support high power operation without damage to average power levels on the order of 1 kW in the foreseeable future. The effects of thermal birefringence in all-fiber optical isolators are difficult to assess presently, and represent an additional uncertainty regarding the future potential for high power operation of all-fiber isolators.

A passive means of effectively compensating thermal birefringence with isolation greater than 25 dB for power levels well in excess of 1 kW has been described [E. A Khazanov, “Compensation of thermally induced polarization distortions in Faraday isolators”, Quantum Electronics 29 (1) 59-64 (1999)]. In this method a 67.5° reciprocal quartz polarization rotator is preferentially used between a pair of identical 22.5° non-reciprocal Faraday rotators such that a linear polarization entering the first Faraday rotator is flipped by 90° upon entering the second Faraday rotator. This polarization flipping substantially cancels thermal birefringence in the isolation direction via the photoelastic effect from thermal strains in each Faraday rotator. A half-waveplate may replace the 67.5° quartz rotator to achieve a similar effect, albeit with reduced birefringence compensation performance at high power. Although this passive means of thermal birefringence compensation is elegant, this method has three drawbacks for practical devices:
It adds extra optical components and overall complexity;
Although it can compensate for thermal birefringence in the isolation direction, the effects of thermal birefringence can be compounded in the forward direction; and
It does not improve thermal lens focal shifts in any way.

For the above reasons, this passive means of thermal birefringence compensation has not been used in high volume commercially available optical isolators for use with high power lasers.

The thermal gradient across the beam radius together with a positive dn/dT results in a positive thermal lens in currently used Faraday rotator optical materials. For this reason, some researchers have explored the use of negative dn/dT optical materials (such as Schott FK51 optical glass or DKDP crystals) to compensate positive thermal lensing in Faraday rotators [E. Khazanov et. al., “Compensation of Thermally Induced Modal Distortions in Faraday Isolators”, IEEE J. Quantum Electron. 40, 1500-1510 (2004)1. However this approach has been found to have some major drawbacks. First, these materials have different thermal conductivity, heat capacity and absorption coefficients, rendering thermal lensing compensation difficult to achieve with dynamic changes in laser power. Second, negative dn/dT materials typically have strong thermal birefringence, such that the resultant poor extinction defeats the original purpose of the optical isolator. Finally, most negative dn/dT materials studied to date have undesirable material properties such as low resistance to thermal shock and/or sensitivity to humid environments. More recently, CaF2 has been shown to be a negative dn/dT material that can have very low thermal birefringence when used near the [111] crystal orientation [the ideal crystal orientation is within 1° of the [111] orientation and is derived in I. Snetkov, A. Vyatkin, O. Palashov and E. Khazanov, “Drastic reduction of thermally induced depolarization in CaF2 crystals with [111] orientation,” Opt. Express 20(12), 13357-13367 (2012)]. Most recently this work with CaF2 has been reported to simultaneously compensate both thermal birefringence and lensing [I. L. Snetkov, O. V. Palashov, E. A. Khazanov, “New Scheme of Faraday Isolator with Simultaneous Compensation of Thermally Induced Depolarization and Thermal Lens,” OSA CLEO Technical Digest 2012, paper JW2A]. This work uses a 73 degree quartz optical rotator in conjunction with an additional separate CaF2 optic outside of the magnetic field. Thermal birefringence within the CaF2 crystal in conjunction with the quartz optical rotator compensates for thermal birefringence in the TGG crystal within the magnet structure of the Faraday rotator. Additionally the negative dn/dT CaF2 at least partially compensates for thermal lensing in the TGG. At a power level of 300 W, the authors report improved performance relative to traditional optical isolators such as shown in FIG. 1. Isolation was improved from 25 dB to 31 dB and thermal lensing was reduced by a factor of 1.25×. Through careful design the authors theoretically estimate 30 dB optical isolators at 1.3 kW using this approach—although they do not state the anticipated thermal lensing.

Although elegant in theory, in practice compensating for undesirable thermal gradients is difficult to achieve at high power. What is desired is a method to practically eliminate the thermal gradient across the beam in a Faraday rotator rather than trying to compensate for it. Such an approach would simultaneously reduce thermal lens focal shifts and thermal birefringence, thereby improving optical isolator performance.

A first method for reducing thermal gradients in a high power Faraday rotator is to use improved Faraday optic materials. Terbium aluminum garnet (“TAG”) in crystalline or transparent ceramic form offers potential advantages as a Faraday rotator material over TGG in the visible and near infrared spectral region. At 1 μm, the Verdet constant of TAG is more than 30% greater than TGG [M. Geho, T. Sekijima and T. Fujii, “Growth of terbium aluminum garnet (Tb3A15012; TAG) single crystals by the hybrid laser floating zone machine”, J. Crystal Growth, V. 267, 188-193, (2004)]. Permutations of TAG, such as TSAG (where some scandium is substituted for terbium) [A. Yoshikawa et. al., “Czochralski growth of Tb3Sc2Al3O12 single crystal for Faraday rotator”, Material Research Bulletin, 37, 1-10 (2002) and D. A. Pawlak et.al., “Growth of Tb—Sc—Al garnet single crystals by the micro-pulling down method,” J. Crystal Growth 226 (2001) 341-347].and TSLuAG (where scandium and lutetium are substituted for terbium) [K. Shimamura et. al. “Growth of {Tb3}[Sc2-xLx](Al3)O12 Single Crystals for Visible—Infrared Optical Isolators,” Cryst. Growth Des. 10(8), 3466-3470 (2010)] have been explored in order to improve crystal growth and yield with only a minimal reduction in TAG Verdet constant have also been described in the literature. Doping small amounts of aluminum into TGG to substitute for gallium at some crystal sites [“TGAG”] may reduce crystal absorption and improve thermo-optic properties relative to undoped TGG [W. Zhang et. al. “Growth and characterization of Tb3Ga5-xAlxO12 single crystal,” J. Cryst. Growth 306 (2007) 195-199]. However, the Verdet constant and thermo-optic improvements that these materials offer relative to TGG are incremental only. In the best case, as exemplified by TAG, these materials may reduce thermal lens focal shifts below that of TGG by a factor of ≈2. Such a reduction in Faraday rotator thermal lens focal shift is insufficient however to make low thermal lens focal shift, kW class optical isolators of simple construction similar to presently available lower power TGG optical isolators. Further, new Faraday rotator materials such as TAG in crystalline or transparent ceramic form are difficult and expensive to bring to the market. To date, TGG remains presently the most proven, broadly available high power Faraday rotator material for the visible and near infrared spectral region. Although the potential for a tremendous advance in high power Faraday rotator optical material still exists, no currently known material has sufficiently improved properties to reduce thermal lens focal shifts and thermal birefringence to a level required by optical isolators to meet high power laser marketplace demands today.

A second method for reducing thermal gradients in a conventional Faraday rotator such as shown in FIG. 1 is to reduce the length of the Faraday optic 4 by increasing the field strength of the permanent magnet structure 5. As noted previously for the prior art exemplified in FIG. 1, commercially viable optical isolators currently use permanent magnets which generate average magnetic fields of ≈10.3 kGauss in the direction of beam propagation over a 2 cm length of TGG centered in the magnet structure. Reports of higher average field strength have been published [see for example, I. Mukhin et. al., “2.1 Tesla permanent-magnet Faraday isolator for subkilowatt average power lasers”, Opt. Comm. 282 (2009) 1969-1972; and G. Trenec et. al., “Permanent magnets for Faraday rotators inspired by the design of the magic sphere”, Appl. Opt. 50, 4788-4797 (2011)]. Magnet dimensions scale very rapidly with the Faraday optic length. Although useful for esoteric research applications, these approaches, and any permanent magnet approach in general, become extremely bulky and expensive relative to existing commercially available isolators when attempting to generate average uniform ˜2 T magnetic fields over Faraday optic lengths of ≧11 mm. Although not practical for high volume single pass optical isolators applications using currently available Faraday optics similar to FIG. 1, these reports do indicate that ˜2 T fields over much shorter Faraday optic path-lengths (e.g. ≦4 mm) are possible with magnet structures comparable or even smaller to the ≈10.3 kGauss average fields currently used with common 2 cm long TGG Faraday optics.

For conventional circularly symmetric laser beams, optical isolators typically use rod shaped Faraday rotator optical elements. In a quest to reduce thermal gradients across a beam, other Faraday rotator optical element geometries have been proposed. The most studied of these have been slab geometries and segmented discs with gas cooled optical faces [E. A. Khazanov, “Investigation of Faraday isolator and Faraday mirror designs for multi-kilowatt power lasers,” in Solid State Lasers XII, R. Scheps, ed., Proc. SPIE 4968, 115-126 (2003)]. In slab geometries a highly elliptical laser beam is transmitted through slab shaped Faraday rotator optical elements having a high aspect ratio (width:thickness≧15) rectangular aperture. By removing heat only from the two large non-optical surfaces of the slab while thermally insulating the other two small non-optical edges, a temperature gradient across the beam in the thin slab dimension only is produced. This thermal gradient along one axis is substantially reduced with high aspect ratio slabs compared to that of a conventional rod shaped Faraday rotator with circular beams. Although reduced in magnitude, a cylindrical thermal lens is formed which can be more difficult to focus properly in an optical system. Additionally, either expensive cylindrical lens systems or complicated off axis spherical mirror systems are required to transform conventional circular beams to a highly elliptical beam and vice versa as desired by conventional laser users. Slab geometry Faraday isolators offer some utility when used with slab geometry solid state laser systems that already employ elliptical beams or with linear arrays of circular beams. However, the factors noted above have kept slab geometries from being broadly employed with conventional circular beam high power laser sources.

Segmented thin discs seek to remove heat through the optical faces of thin discs, rather than through the non-optical faces of thin slabs in order to realize the benefits of thin slabs without the problems noted above. Segmented thin disc Faraday rotator optical elements reported in the literature remove heat through the optical faces by flowing helium gas over them. In theory, heat flow occurs primarily in the direction of beam propagation [I. B. Mukhin, E. A. Khazanov, “Use of thin discs in Faraday isolators for high-average-power lasers,” Quantum Electronics 34(10) 973-978 (2004)]. This greatly reduces the thermal gradient across the beam profile responsible for thermal lensing and birefringence when the segmented discs are thin. This approach is most effective if the beam radius is at least twice that of each disc thickness in order to essentially eliminate thermal gradients across the beam. However, substantial benefits are possible enabling useful optical isolators up to the kW level even for beam radii equal to disc thickness. For TGG, V(1070 nm, 293K)=2.16 deg/(KGauss-cm). Hence for ˜2 T magnet fields (near the practical limit for permanent magnets), ≈1.1 cm total length of TGG is required. This corresponds to 11 segments of 1 mm thick TGG discs that must also provide spacing for gas cooling. Due to the cost and complexity of multiple optical elements and helium gas systems specified however, such designs have not been employed beyond research lab environments to date and do not appear destined for practical industrial usage.

Faraday rotator materials with much higher Verdet constant than TGG (e.g. ˜2-3×) would reduce the number of discs such an approach would require, and thereby make this approach potentially viable. However, at this time no known Faraday material with such a desired Verdet constant suitable for use with kW class lasers is commercially available.

What is needed are simultaneously low thermal lens focal shift and low thermal birefringence broadband Faraday rotators suitable for use in practical Faraday effect devices such as optical isolators which are stable in the presence of dynamically shifting power levels scalable up to and in excess of 2 kW.

### SUMMARY

According to the invention, transparent heat-conductive layers of thermally significant thickness are bonded or adhered to opposing optical faces of a Faraday optic to form a Faraday optic structure that can be used with beam-folding mirrors and an external magnetic field to form a multi-pass Faraday rotator with minimal thermal gradient across the beam within the Faraday optic. The transparent heat conductive layers conduct heat through the Faraday optic substantially parallel to the beam propagation axis for each pass through the Faraday optic structure and thereby reduce thermal gradients across the beam cross section that would otherwise contribute to thermal lens focal shifts and thermal birefringence in the Faraday optic structure. The multi-pass Faraday rotator of this invention is suitable for use with any device based upon the Faraday effect such as optical isolators, optical circulators and Faraday mirrors that are scalable with beam size to power levels in excess of 2 kW.

In one aspect of the invention the transparent heat conductive layers of the Faraday optic structure are anti-reflection coated windows formed of synthetic diamond bonded or adhered to the optical faces of a Faraday optic. External mirrors are used in conjunction with the Faraday optic structure to form a multi-pass beam path through the Faraday optic structure to achieve the desired Faraday rotation. It is another aspect of the invention that the transparent heat conductive layers are hydrogenated “diamond-like” carbon [“DLC”] or non-hydrogenated tetrahedral carbon [“ta-C”] films adhered directly to the optical faces of the Faraday optic. It is another aspect of the invention that Faraday optics are directly grown on, or in the case of ceramics is sintered onto, substrates that function as the transparent heat conductive layers or windows in accordance with the invention.

In another aspect of the invention, at least one of the transparent heat conductive layers of the Faraday optic structure has a dn/dT coefficient that is of opposite sign relative to the Faraday optic in order to at least partially compensate phase shifts in the Faraday optic due to any residual thermal gradients in the Faraday optic structure. In accordance with this aspect of the invention, such transparent heat conductive layer may be a fluoride crystal such as CaF₂.

In yet another aspect of the invention one, or both, of the transparent heat conductive layers of the Faraday optic structure has a highly reflective coating applied to a portion of its external optical surface to form an integral fold mirror replacing one, or both, of the external fold mirrors of the multi-pass Faraday rotator. This aspect of the invention also contemplates that the transparent heat conductive layers functioning as integral fold mirrors need not be monolithic. Hybrid transparent heat conductive layers comprised, for example, of low dn/dT materials such as fused silica can be bonded or adhered to thin DLC or ta-C films to function as an integral fold mirror according to the invention.

The invention will be better understood upon reference to the following detailed description with the accompanying drawings.

### BRIEF DESCRIPTION OF THE DRAWINGS

FIG. 1 is a schematic view of an optical isolator according to the prior art.

FIGS. 2a-c are illustrations of the steps of the modeling method to calculate thermal lens focal shifts.

FIG. 3a shows a Faraday optic structure comprised of TGG and transparent heat conductive windows in accordance with the invention.

FIG. 3b shows a radially cooled TGG slab Faraday optic in accordance with prior art.

FIG. 4 is a schematic plan view of the FIG. 3 Faraday optic structure and the other elements of a broadband 2 kW PI multi-pass optical isolator in accordance with the invention.

FIG. 5 is a side view of the elements shown in FIG. 4 in accordance with the invention as viewed from the bottom side of FIG. 4.

FIG. 6 is a schematic plan view of a multi-pass Faraday rotator including a Faraday optic structure comprised of TGG and oppositely signed dn/dT CaF₂ transparent heat conductive windows in accordance with the invention.

FIG. 7 is a schematic plan view of a multi-pass Faraday rotator used in a 600 W PM optical isolator in accordance with the invention with a Faraday optic structure including integral CaF₂ mirrors.

FIGS. 8a-c are copies of FIG. 8, FIG. 11 and FIG. 19, respectively, of prior art multi-pass optical isolators disclosed in U.S. Pat. No. 5,715,080 “Compact Uniform Field Faraday Isolator”.

### DETAILED DESCRIPTION OF THE INVENTION

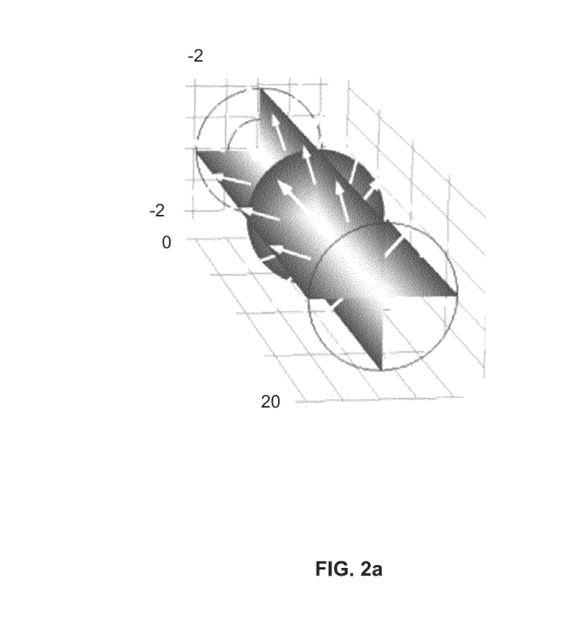

The invention can best be understood by first examining thermal lensing focal shifts that result from thermal gradients across the beam cross section transmitted through the Faraday rotator optic within an optical isolator. The well-known method employed is summarized in FIG. 2 [see for example Slim Hamdani, “Faraday thermal lensing numerical simulations” LIGO Scientific Collaboration meeting 25/05/07, publication number LIGO-G070358-00-Z]. In this approach a finite element program is first used to model temperature gradients, ΔT(r,z), across a laser beam transmitted through a Faraday optic of length L. Phase shifts Δyφ(r) across the beam resulting from traversing the heated Faraday optic are given by:

$$Δϕ ( r ) = \frac{2 π}{λ} {\int }_{0}^{L} Δ T ( r , z ) \frac{d n}{d T} d z \qquad eqn . 5$$

Here the two relatively minor effects of thermally induced stress and thermal elongation of the Faraday optic upon the change in refractive index Δn(r,z) are neglected such that only the dominant temperature dependency of the refractive index is considered, i.e. Δn(r,z)=ΔT(r,z)dn/dT. Up to the waist radius (1/e² intensity point) of a Gaussian beam, the radial phase shifts Δyφ(r) are fitted to a parabola, and higher order curve fitting terms are ignored:

Δφ(r)=a₁+a₂r²+0r⁴ eqn. 6

For a paraxial spherical lens of focal length f:

$$Δϕ ( r ) = \frac{2 π}{λ} \cdot \frac{{r}^{2}}{2 f} \qquad eqn . 7$$

Equating equal powers of r in eqn. 6 and eqn. 7 above gives the thermal lens focal length due to temperature gradients in the Faraday optic:

$${f}_{TL} = \frac{π}{λ \cdot {a}_{2}} \qquad eqn . 8$$

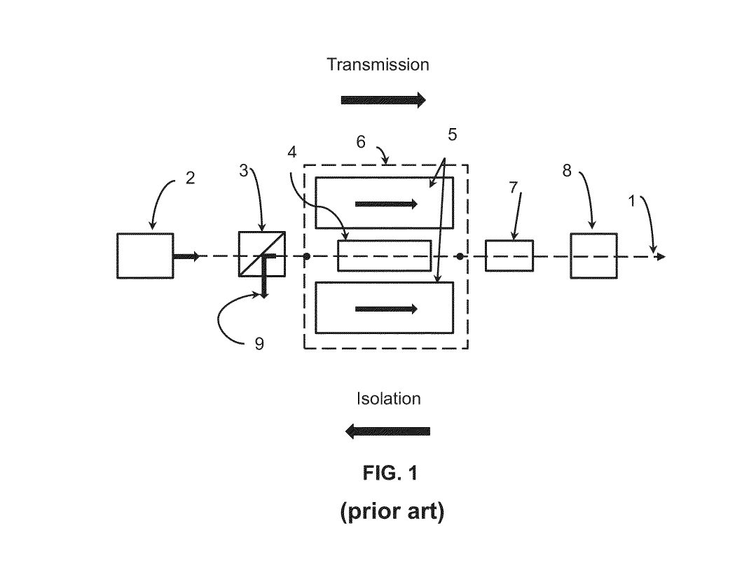

Finally, focal shifts due to the thermal lens are simply determined using an ABCD matrix analysis where the thermal lens is modeled as a paraxial thin lens and the focal shifts are expressed relative to the Rayleigh range Z_{R} of the focused spot with no thermal lens present as shown in FIG. 1. Although this method does not account rigorously for aberrations in the thermal lens, it does provide a simple means for gauging first order thermal lensing in weakly absorbing optics.

The method for analyzing thermal lensing focal shifts outlined in FIG. 2 is first applied to the prior art to establish a baseline for which to better understand the invention. FIG. 1 is a schematic representation of an optical isolator commonly used in the art. Polarization beam splitter cube [“PBS cube”] 3 ensures a highly linear polarization of laser radiation of center wavelength λ_{c} from source 2 directed along axis 1. Faraday rotator 6 comprised of Faraday optic 4 and magnet(s) 5 rotates the radiation plane of linear polarization out of PBS cube 3 by nominally 45 degrees. The transmission axis of PBS cube 8 is aligned parallel to the linear polarization incident upon it from radiation source 2. Optional 45 degree quartz rotator 7 can be added to make the optical isolator broadband as is commonly used in the art. The Faraday optic 4 of Faraday rotators operating at λc=1064 nm is commonly 2 cm of terbium aluminum garnet [“TGG”] single crystal or polycrystalline ceramic.

A 4 mm diameter TGG crystal that is 2 cm long was modeled with a finite element numerical simulation (Comsol Multiphysics V. 4.3a with heat transfer module). The input parameters for the finite element model are:
TGG absorption coefficient: ≦0.0015 cm⁻¹
TGG thermal conductivity: 7.4 W/(m-K)
TGG Density: 7320 kg/m³
TGG dn/dT: 1.9×10⁻⁵ (K⁻¹)
TGG heat capacity: 385 J/(kg-K)
Laser source wavelength: 1070 nm
Laser source power: 1000 W
Laser source 1/e² waist (radius): 1 mm
Ambient temperature: 293.15 K
TGG rod cylindrical surface temp: 293.15 K

The finite element computer model result of these inputs is shown in FIG. 2a where it is seen that the maximum on axis temperature it 297.52° K—representing a 4.37° C. temperature rise above the ambient temperature. The arrows in FIG. 2a graphically show that all of the heat flow is radial across the beam. This radial heat flow creates a largely parabolic phase shift across the beam that functions as a positive thermal lens.

Integrations parallel to the TGG rod axis were made starting at the rod axis and in radial displacement increments of 0.1 mm according to eqn. 5. The results are plotted in FIG. 2b. Away from the beam axis the correlation of parabolic fit to the finite element model is not optimal—largely due to filling the TGG rod with such a high power Gaussian spatial profile beam. The parabolic fit is much better when clear aperture radius/beam radius ratios are larger than the chosen ratio of 2—which was selected to model practical, low cost devices. For consistency with later modeling, the parabolic fit is forced to occur at the 1/e² beam radius rather than closer to the beam axis where the fit is much better. In accordance with parabolic eqn. 6 a₂=4.61 [l/mm²], and eqn. 8 gives f_{TL}=637 mm for the thermal lens of a conventional TGG rotator at 1 kW of input power.

A schematic representation of an optical system with focal shifts due to thermal lensing is shown in FIG. 2c. Using a positive thermal lens of f_{TL}=637 mm in an ABCD matrix program gives a resultant thermal lens focal shift of Δz_{TL}/z_{R}=−3.98. This value is lower by a factor of two relative to that stated previously in paragraph [0016] (Δz_{TL}/z_{R}≈−8) because the parabolic fit has been forced to extend to the 1/e² beam radius for modeling consistency. A value of a₂≈9 gives a much improved parabolic fit in the region near the beam axis which where the beam is more intense such as would be reflected in Gaussian weighted fitting of the parabola.

The thermal birefringence of conventional Faraday rotators has been found to closely follow the models presented by K. Nicklaus and T. Langer, “Faraday isolators for high average power fundamental mode radiation”, Proc. of SPIE Vol. 7578, (2010) and Khazanov et. al. “Effect of Terbium Gallium Garnet Crystal Orientation on the Isolation Ratio of a Faraday Isolator at High Average Power,” Appl. Opt. 41, 483-492 (2002). For the typical [111] orientation of TGG single crystal or TGG ceramic the following equation for thermal depolarization γ caused by thermal birefringence applies:

$$γ ( [ 111 ] ) = \frac{{p}^{2}}{9 {π}^{2}} {H ( 1 - 2 ξ )}^{2} \\ where \\ p = \frac{L}{λ} \frac{α Q}{κ} {P}_{0} \qquad eqn . 9$$

Where H is a beam shape dependent parameter equal to ≈0.13 for a Gaussian beam with our TGG rod radius to beam ratio, ξ is a photo-elastic tensor parameter equal to 2.22, L is the rod length, λ is the wavelength, κ is the thermal conductivity (7.4 W/(m-K)) and αQ is a crystal quality dependent product which we take to be 3.7×10⁻⁷ K⁻¹ m⁻¹ although it has been measured to be as low as 2.5×10⁻⁷ K⁻¹ m⁻¹ for high quality TGG [Mueller et.al., Classical and Quantum Gravity, 19, 1793 (2002)]. In this product, a is the absorption coefficient which is specified as α≦0.15 m⁻¹. P₀ is the incident power (1 kW). Using the parameters associated with FIG. 2, eqn. 9 gives γ=0.0148 or 18 dB by the relation γ(dB)=−10 log (γ). A simple kW class Faraday rotator which significantly improves upon the values of ΔZ_{TL}/Z_{R}=−3.98 for the thermal lens focal shift and γ=18 dB for the thermal birefringence is the goal of the present invention.

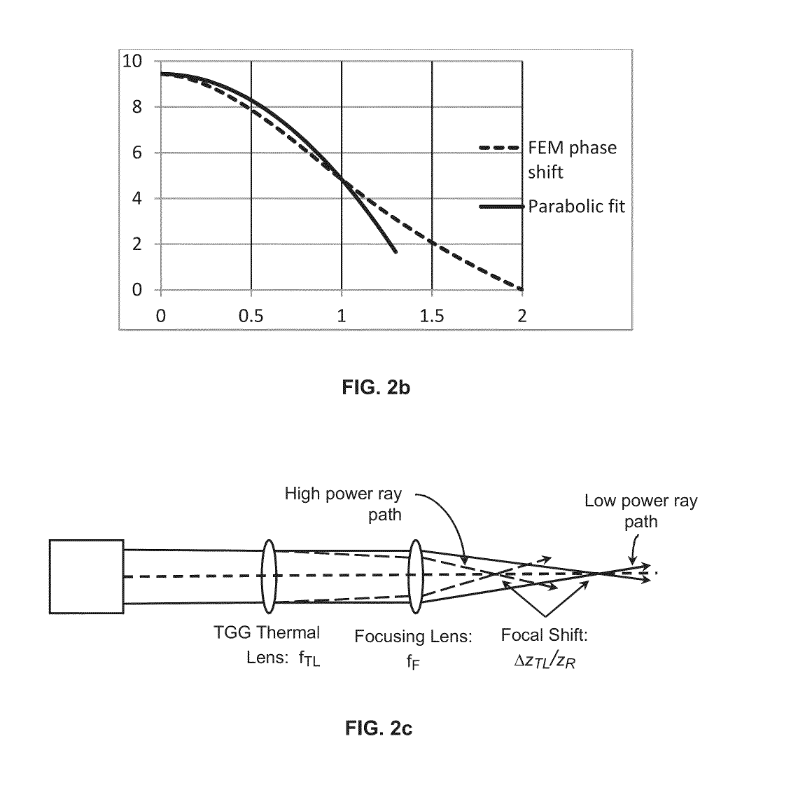

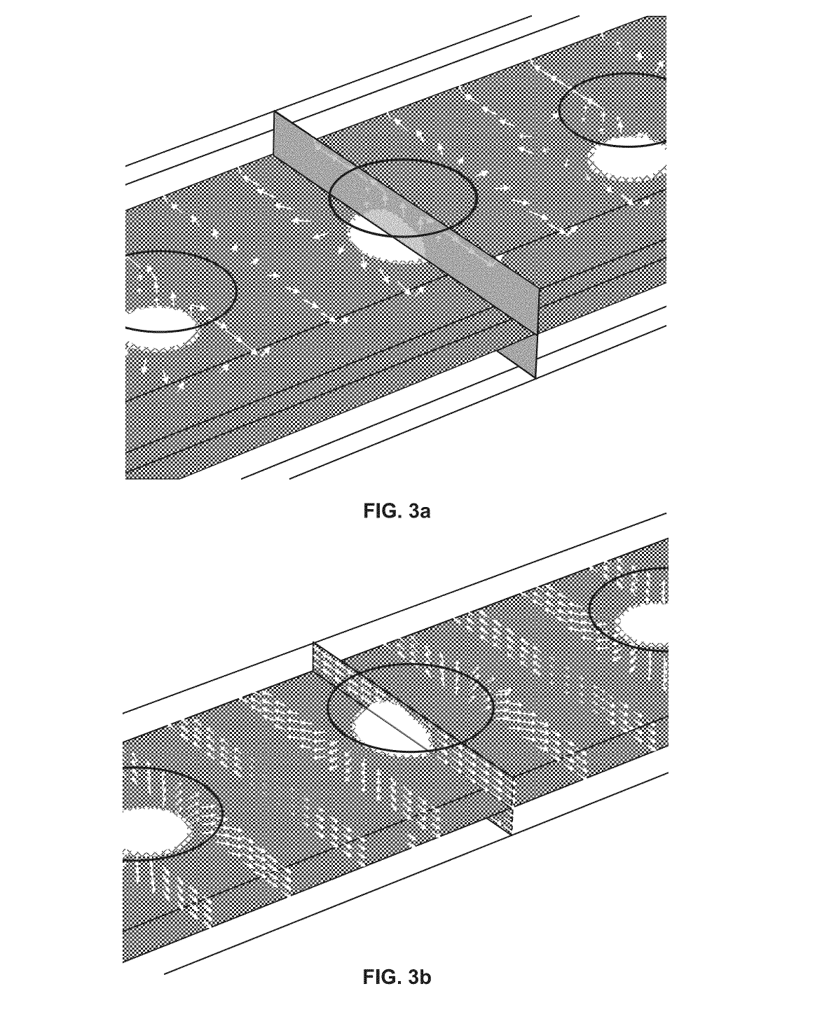

Similar methods to model thermal lens focal shift and thermal birefringence can now be applied to the Faraday optic structure of the invention. In accordance with the present invention, FIG. 3a is a finite element thermal model of Faraday optic structure comprised of transparent heat conductive layers bonded or adhered to the optical faces of a Faraday optic suitable for use in a multi-pass Faraday rotator. A 0.8 mm thick Faraday optic slab of TGG has transparent heat conductive 0.3 mm thick synthetic diamond windows bonded to each optical surface. Three 1 kW average power laser beams of 1 mm radius each are incident on the laminated optical structure to model heat flow within the Faraday optic structure when used in a high average power multi-pass Faraday rotator. The TGG parameters are the same as for the TGG rod analyzed above. Synthetic diamond windows are available, for example, from Diamond Materials, Tullastr. 72, 79108 Freiburg, Germany. Parameters for the synthetic diamond windows used in the model are:
Thermal conductivity: 1800 W/(m-K)
Density: 3.515 g/cm³
Specific heat @20° C.: 0.502 J/gK
dn/dT: 1×10⁻⁵ l/K
Absorption coefficient: negligible

A 1 mm conductive cooling strip is modeled around the perimeter of the face of each synthetic diamond cooling window as seen for the top window in FIG. 3a (a similar cooling strip on the bottom window is obscured in this figure). The three circles in FIG. 3a delineate the 1/e² intensity limits of each beam and the laminated structure is sized to allow a clear aperture equal to twice the size of the 1/e² dimensions of the beam as for the standard-in-the-art baseline study. Otherwise the thin edges of the laminated TGG Faraday optic structure are thermally insulated to minimize radial heat flow.

From the model of FIG. 3a the maximum temperature rise for the central beam is 0.78 K. The average temperature on-axis temperature is 293.687 and the average temperature at a radius=1/e²=1 mm is 293.302. This gives an average temperature difference of only 0.385K between the center of the beam and the 1/e² radius. The multi-slice plot (planar slices midway through the Faraday optic structure along the x and z axis) also shows the flow of heat is nearly completely along the beam axis within the TGG and then flows through the conductive transparent synthetic diamond windows to the heat sinking conductive cooling strips. Using the methodology outlined in FIG. 1, the thermal lens focal length due to the central beam is found to be f₁=−85.6 m or φ₁=−0.0117 diopters. For TGG, the Verdet constant is V(1070 nm, 295K)=2.165 deg/(kG-cm). As noted in the background section, although impractically large for widespread optical isolator application with typically 20 mm long Faraday optics, 20 kGauss permanent magnetic fields are practical for smaller Faraday optic dimensions of ≈4 mm or less—a key practical aspect of the present invention. Therefore with a magnetic field H of ˜20 kGauss, 45 degrees of Faraday rotation (as is typically required in an optical isolator) from eqn. 1 requires a total TGG length of L=1.1 cm or 13 passes of the laminated 0.8 mm TGG Faraday optic structure. For each successive pass of the laminated TGG Faraday optic structure φ₁=φ₂=φ₃ . . . =φ₁₃. Because |φ|=0.0117 diopters<<1, we can write by Gaussian reduction:

φ_{T}=φ₁+φ₂+φ₃ . . . φ₁₃

φ_{T}=−0.152 m⁻¹

and

f_{TL}=1/φ_{T}=−6.6 m

Using an ABCD matrix analysis this overall multi-pass thermal lens relates to an overall thermal lens focal shift of Δz_{TL}/z_{R}=−0.43—representing nearly a 10 fold improvement over that of the standard art value of Δz_{TL}/z_{R}=−3.98 calculated above.

The thermal depolarization γ of thin disk TGG Faraday rotators cooled by flowing helium gas across the disc faces has been calculated by I. B. Mukhin, E. A. Khazanov, “Use of thin discs in Faraday isolators for high-average-power lasers,” Quantum Electronics 34(10) 973-978 (2004) and summarized in FIG. 3 of that paper. Since the diamond layers are superior heat conductors relative to flowing helium gas, these results can also conservatively be applied to the laminated Faraday optic structure of this invention. For a beam radius, r₀, to TGG disk thickness, h, aspect ratio of r₀/h=2 (labeled as plot 4 in their figure), they calculate γ≈3×10⁻⁵ for a 3.2 cm long TGG rod with crystal quality parameter αQ=2.5×10⁻⁷ K⁻¹m⁻¹. For FIG. 3a above we have an aspect ratio of r₀/h=1 mm/0.8 mm=1.25 and a total TGG length of 1.1 cm and a crystal quality parameter of αQ=3.7×10⁻⁷ K⁻¹m⁻¹. Since they show that γ is inversely proportional to the fourth power of this aspect ratio and proportional to L² and (αQ)², the thermal birefringence of the FIG. 3a multi-pass Faraday rotator is predicted to be γ≈0.00005 or 43 dB. It should be noted that maintaining the same aspect ratio of r₀/h=1.25 while increasing the TGG Faraday optic thickness h can reduce the total number of passes required through the multi-pass Faraday rotator. Therefore scatter and coating losses associated with each pass can be reduced for the overall device—but at the expense of larger magnet structures to support the correspondingly larger beam radius.

In order to better understand the invention, FIG. 3b shows heat flow in a 0.8 mm thick TGG Faraday optic slab that is cooled along its peripheral, non-optical, surfaces such as in prior art Faraday rotators under the identical conditions used to model the FIG. 3a Faraday optic structure of the current invention. The x and y dimensions are again dimensioned to ensure a clear aperture 2ω₀ radius around each axis of the three 1 kW laser beams. The peak temperature in the center of the TGG slab for the central beam is 5.59K. In clear contrast to the heat flow within the TGG of the Faraday optic structure of FIG. 3a along the beam-path, the heat flow in FIG. 3b is clearly radial away from the beam axis and towards the cooled peripheral edges of the TGG slab.

It is possible to consider a linear segmented disc Faraday rotator that replaces the flowing helium gas as taught by Mukhin and Khazanov with a high thermal conductivity, low dn/dT transparent material such as sapphire, germanium or silicon in the infrared. Negative dn/dT materials with moderately higher thermal conductivity such as CaF₂ could also be considered. In such an approach segments of sapphire or CaF₂, possibly of larger diameter than the Faraday rotation discs for easy heat removal through their peripheral, non-optical surfaces and insulation against radial heat flow in the Faraday optics, would be optically contacted to each face of the Faraday rotator discs. However, this approach has a few practical drawbacks:

Twelve sapphire or CaF₂ conductive windows would need to be optically contacted to 11 TGG discs for the example of a 1 mm beam radius and disc thickness in a 2 T magnetic field. A high yield for optically contacting 22 surfaces with low interface losses using these materials is a daunting practical task;

Each sapphire or CaF₂ conductive window would reasonably need to be of similar thickness as each TGG disc for an overall optically contacted stack length of ≧23 mm. Although possible in theory, in practice very large and expensive permanent magnet structures are required to generate uniform 2 T magnetic fields over gap lengths of >23 mm. Lower fields and more TGG/conductive window disc pairs could be added, however this would increase interface losses and yield issues described above.

By using larger beam diameters the number of TGG discs could be reduced by increasing the thickness of each disc, however the corresponding increase in aperture size would similarly increase the magnet assembly size and cost.

In order to minimize reflections between TGG and synthetic diamond surfaces in the laminated Faraday optic structure with refractive indices of 1.944 and 2.39 respectively, index matching thin film coating layers are applied to at least one or both of the optical surfaces prior to making each bond between these materials at each optical face. Preferably adhesive free bonding is used and can be by any of the methods related to optical contacting known in the art such as diffusion bonding, Adhesive-Free Bonding “AFB®” (Onyx Optics, Inc., 6551 Sierra Lane, Dublin, Calif. 94568) or Chemical Activated Direct Bonding “CADB®” (Precision Photonics, 5733 Central Avenue, Boulder, Colo. 80301). Due to residual absorption and low thermal conductivity, bonding the optical surfaces with transparent adhesives (absorption coefficient ≦0.1 cm⁻¹) is not feasible at very high power and can only be contemplated in accordance with the invention where power levels or optical beam fluence is consistent with the damage threshold of thin layers (˜10 μm or less) of such adhesives when sandwiched between the transparent heat conductive layer and the heat generating Faraday optic.

Although the 300 μm thick synthetic diamond windows of FIG. 3a help show the heat flow in the laminated TGG Faraday optic structure, they need not be so thick. Because the thermal conductivity of the synthetic diamond windows is so very high, reducing their thickness to 20 μm gives nearly identical results in the finite element analysis. Such thin thicknesses are still available as separate windows, however such thicknesses also enable the use of diamond-like carbon “DLC” (hydrogenated form) or “ta-C” (nonhydrogenated tetrahedral form) layers to be sputtered directly onto the Faraday rotator substrate if similar index or onto anti-reflection thin film index matching layers previously applied to the TGG Faraday optic material (for example Hybrid-DLC coatings available from JENOPTIK Optical Systems GmbH, Gorschwitzer Strasse 25, 07745 Jena, Germany). DLC or ta-C have thermal conductivity that is still extremely high 1100 W/(m-K) and functionally similar to synthetic diamond windows in accordance with the invention. Because these materials can have a small amount of scattering at near-infrared wavelengths desired for many Faraday rotators, thin layers of synthetic diamond windows or DLC coatings are preferred to minimize the overall magnitude of scattered radiation in the multi-pass approach of this invention. Controlling the thickness of the DLC or ta-C layers to a low integer multiple of the laser wavelength plus one-quarter wavelength allows the diamond-like carbon layers to function as anti-reflection coatings.

Because synthetic diamond has high transmission and low scatter well beyond 10 μm (high transmission is reported out to as far as 100 μm) this approach is also particularly suited for CO₂ multi-pass Faraday rotators and optical isolators in the mid-infrared and other potential Faraday rotators and optical isolators in the far-infrared. For example, a high power multi-pass Faraday rotator can be constructed in accordance with the present invention by substituting mid-infrared Faraday rotation optics for the thin TGG in the transparent thermally conductive diamond layer structure of the invention discussed above. Such mid-infrared Faraday rotation optics may include semiconductor arsenides or antimonides such as Si doped GaAs, undoped GaSb or InSb in the mid-IR and IR Transparent thermally conductive layers that have a higher refractive index than diamond such as silicon or germanium are also useful with these semiconductor materials. Silicon in the mid-IR (n≈3.4 and a high thermal conductivity of 149 W/(m-K) and germanium in the IR (n≈4 and thermal conductivity of 60 W/(m-K)) as transparent thermally conductive layers can be good refractive index matches for arsenide and antimonide semiconductor Faraday optics even without index matching coating layers between materials. Undoped (or low doped) semiconductors such as InAs can be useful in broadband optical isolators in the spectral region of 4-7 μm where Faraday rotation due to inter-band transitions is predominant over oppositely signed free carrier Faraday rotation [U.S. Patent Application No. 61/727,494, Amir A. Jalali “Broadband semiconductor Faraday effect devices in the infrared It is another aspect of the invention that Faraday rotation layers such as semiconductor arsenides or antimonides are grown directly onto transparent heat conductive window substrates such as silicon or germanium to form a Faraday optic/window structure. In this aspect of the invention, for example, it can also be convenient to polish the exposed Faraday rotation layer optical surface grown on such a silicon or germanium substrate wafer, dice the wafer and then bond the Faraday rotation layer surfaces together, for example by optical contacting. Similarly, in another aspect of the invention thermally conductive transparent pre-sintered ceramic windows which are flat and polished such as undoped YAG ceramic or Lutetium Oxide ceramic are contacted to the optical faces of a similarly pre-sintered flat polished faces of a Faraday rotation ceramic such as TGG. The entire sandwiched structure is then given final sintering to promote proper grain growth and low porosity as desired for high ceramic transparency.

Other window materials such as, for example, undoped YAG, silicon and c-axis Sapphire along with many others depending upon high transmission in the wavelength region of interest, can be used as transparent heat conductive layers of the Faraday optic structure in accordance with the invention. The important parameters for undoped YAG are: thermal conductivity=13 W/(m-K) and dn/dT=7.3×10⁻⁶ K⁻¹; for silicon: thermal conductivity=149 W/(m-K) and dn/dT ˜1.75×10⁻⁴ K⁻¹ in the mid-IR; and for c-axis Sapphire: thermal conductivity=23.1 W/(m-K) and dn/dT=1.3×10⁻⁵ K−1. C-axis Sapphire must be specified because Sapphire is weakly birefringent.

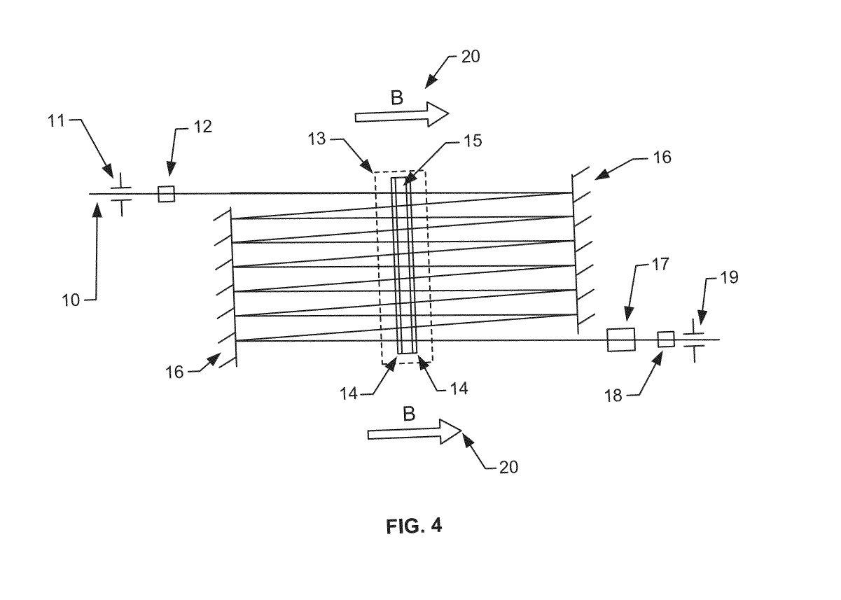

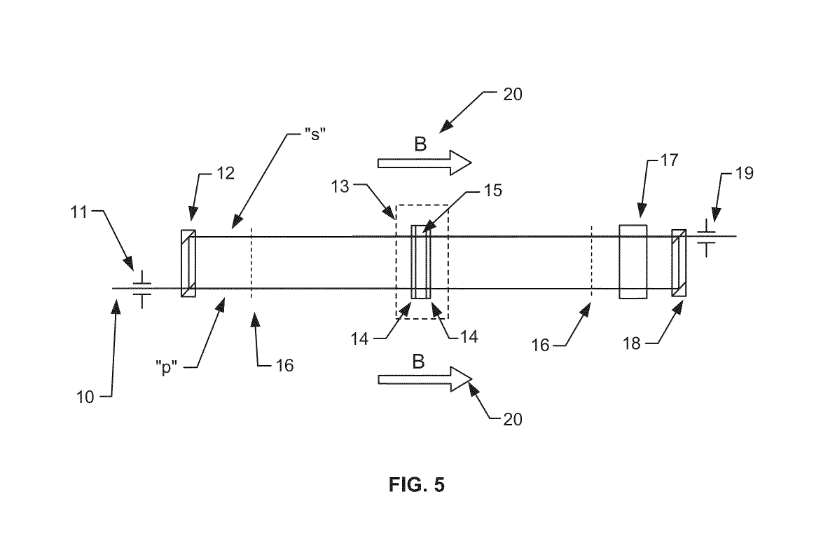

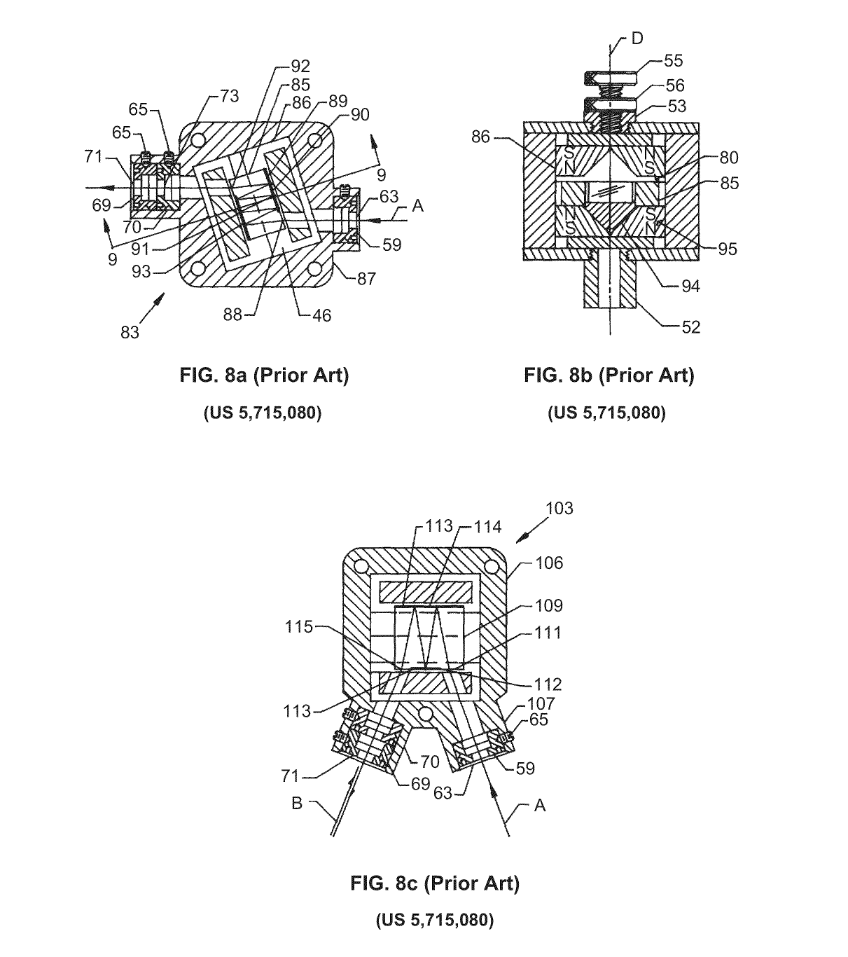

It is now appropriate to consider how the Faraday optic structure of FIG. 3a can be used in a multi-pass Faraday rotator in accordance with the invention. Prior art multi-pass Faraday rotators and isolators can provide a context for the use of the Faraday optic structure of this patent in Faraday rotators and optical isolators in accordance with the invention. FIG. 4 is a plan view of the essential elements of a multi-pass 2 kW PI optical isolator which uses the TGG Faraday optic structure of FIG. 3a in accordance with one embodiment of the present invention for use, for example, with a 2 kW randomly polarized fiber laser. FIG. 5 is a side view of the elements in FIG. 4. Referring to FIG. 4, 1 mm radius randomly polarized 2 kW fiber laser collimated radiation is directed along beampath 10 through 4 mm diameter input aperture 11. As shown in FIG. 5, an input fused silica polarizing beam splitting displacer 12 [“PBS displacer”] defines “s” and “p” polarization axis that are displaced 6 mm relative to one another as shown to resolve the randomly polarized fiber laser output directed along beampath 10 in FIG. 4 into two beams of substantially equal power (≈1 kW each). Two external broadband high reflective mirrors 16 are sufficiently spaced away from the Faraday optic sandwich structure such that they reflect these two beams with minimal overlap in a plan view as shown in FIG. 4 through 13 passes of the Faraday optic structure 13 (inside dashed lines comprised of 0.3 mm thick synthetic diamond windows 14 bonded to 0.8 mm thick TGG Faraday optic 15) very nearly coaxially with the externally applied 2 T permanent magnetic field 20. Both “s” and “p” polarized beams are transmitted through a 45° quartz optical rotator 17 to ensure broadband operation of the PI isolator (as discussed previously in the prior art background section) before being recombined into a single beam as shown in FIG. 5 with an output PBS displacer 18 identical to the input PBS displacer 12. Spaced apertures on the output beam help ensure that any backwards radiation entering through 4 mm output aperture 19 that is directed towards input aperture 11, must make the desired 13 passes of the Faraday optic 15 in order to be rejected at input PBS displacer 12. In summary, ≈2 kW of randomly polarized fiber laser radiation passes through a broadband PI optical isolator with isolation greater than 30 dB and thermal lens focal shifts of less than 0.5z_{R} per kW up to 2 kW is possible with these parameters in accordance with the invention.

According to the invention, at the expense of larger components (largely the permanent magnets) the beam diameter can be increased as required relative to the TGG thickness in order to keep thermal gradients within the Faraday optic structure consistent with the desired thermal lens focal shift and isolation required for a given laser source at power levels in excess of 2 kW. Although the thermal lens of each pass is very small—and is partially offset by the small divergence of the beams along the paths between the Faraday optic structure and the external fold mirrors, there is a very slight reduction in beam radius as a high power beam propagates through the multi-pass isolator. For this reason, locating the waist of a low power beam from the fiber collimator ideally in the center of the final pass of the Faraday optic structure is a best practice to maintain collimated waist location at high power and minimizer thermal lens focal shift.

In accordance with another aspect of the invention, at least one of the transparent heat conductive layers of the Faraday optic structure has a dn/dT coefficient that is opposite in sign from the Faraday optic in order to compensate phase shifts in the Faraday optic due to thermal gradients across the beam in the Faraday optic structure. Fluoride crystals such as BaF₂ and CaF₂ are known to have negative dn/dT coefficients that are of opposite sign to positive dn/dT Faraday optic materials such as TGG. CaF₂ has particularly desirable material properties in accordance with the invention. These properties for CaF₂ are available on the Corning Incorporated Semiconductor Optics website (Corning Incorporated, One Riverfront Plaza, Corning, N.Y. 14831):
Thermal conductivity: 11.9 W/(m-K)
Heat capacity: 853 J/(kg-K)
Density: 853 kg/m³
dn/dT: −1.15×10⁻⁵ K⁻¹
Absorption coefficient @1064 nm: 2×10⁻⁵ cm⁻¹
Spectral range of high transmission: 0.12 μm to 7.5 μm

In accordance with the present invention, CaF₂ functions importantly as both a highly transparent conductive window to remove heat from the thin multi-pass Faraday optic to reduce thermal gradients across the beam and as a means to compensate positive thermal lensing in the Faraday optic material due to residual thermal gradients by the combined effect of the negative dn/dT and thermal gradients within the CaF₂. As noted previously in the background section for the use of CaF₂ solely as a −dn/dT compensation material in a conventional rotator, the propagation of multi-pass radiation along the [111] orientation is preferred to minimize depolarization within the CaF₂.

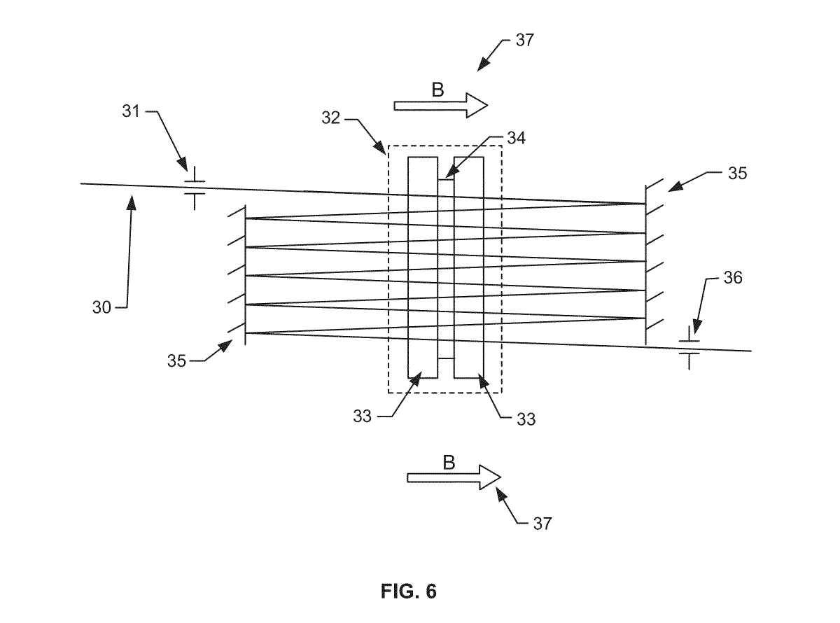

FIG. 6 is a schematic plan view of a multi-pass Faraday rotator including a Faraday optic structure 32 using highly transparent, thermally conductive CaF₂ windows 33 bonded without adhesive to a TGG Faraday optic 34 in accordance with the invention. The TGG Faraday optic 34 measures 1 mm thick by 2.5 mm wide (perpendicular to the plane of FIG. 6) by 12 mm long. The optical faces of the TGG Faraday optic 34 and/or CaF₂ windows 33 are thin film coated to match the TGG Faraday optic 34 refractive index of 1.944 to the CaF₂ window 33 refractive index of 1.4285 prior to bonding to each other. It is further desirable that the thin film coating materials also help mitigate the room temperature 2× difference in thermal expansion coefficients between CaF₂ (18.7 ppm per ° C.) and TGG (9.4 ppm per ° C.). The CaF₂ windows 33 are 2 mm thick by 5.5 mm wide by 12 mm long. They are held at room temperature (293.15K) by conduction on their non-optical perimeter surfaces. Heat is allowed to radiate through all other surfaces of the CaF₂ windows 33 except for the thermally insulated protruding region adjacent to the non-optical surfaces of the 1 mm thick TGG Faraday optic 34. The CaF₂—TGG optical interfaces are bonded without adhesive through any of the various optical contacting related methods noted previously for the FIG. 3a Faraday optic structure. In this model all optical surfaces and interfaces are made non-reflective. A small beam radius of 0.5 mm for incident beam 30 is used so that after passing through 2 mm diameter input aperture 31 a low external incident angle can be used to fold the multi-pass beams through the TGG without significant overlap and keep them parallel to the [111] orientation of the CaF₂. The TGG material parameters are the same as noted previously for FIG. 1.

Successive passes of a 1 kW diffraction limited beam 30 at 1070 nm are each separated by 2 mm from each other upon multiple passes through the composite TGG-CaF₂ Faraday optic structure prior to exiting the multi-pass Faraday rotator through exit aperture 36. Due to the combined effect of heat removal through the TGG Faraday optic 34 optical faces by the heat conductive transparent CaF₂ windows 33 and the opposite signs of dn/dT for the two materials of Faraday optic structure 32, the integration of phase shift across the full TGG-CaF₂ Faraday optic structure 32 according to eqn. 5 gives extremely low total phase shifts. The on-axis phase shift for a single pass is only +0.038 rad, the phase shift at w₀ is −0.064 rad and the phase shift at the 2w₀ is −0.11 rad. Hence for a single pass of the Faraday optic structure, the maximum phase difference over essentially all power of the beam is only (0.038+0.11) rad=0.15 rad. As for the discussion of FIG. 3a, in this case 11 passes of 1 mm thick TGG is required for magnetic fields 37 of ˜2 T. Consequently the total phase shift across the beam for all multi-passes of the Faraday optic structure is only 1.6 rad or about λ/4—a good practical specification for a high power optical component. Note that the use of two CaF₂ windows 33 to remove heat from the relatively thin TGG slab keeps temperature/phase shifts across the beam in the TGG Faraday optic 34 low. The negative dn/dT of the two low absorbing CaF₂ windows 33 of small thickness can then effectively compensate the thermal phase gradients due to the TGG without any additional doping of absorbing species into the CaF₂ as was used to test CaF₂ for use with conventional Faraday rotators as described in the literature [I. Snetkov, A. Vyatkin, O. Palashov and E. Khazanov, “Drastic reduction of thermally induced depolarization in CaF₂ crystals with [111] orientation,” Opt. Express 20(12), 13357-13367 (2012)].

The aspect ratio for the TGG Faraday optic 34 of FIG. 6 is r₀/h=0.5 which is somewhere between conventional “rod-like” and “thin-disc”. Using the same approach to estimate thermal birefringence as per FIG. 3a above but with r₀/h=0.5 (L and αQ remain the same), one arrives at a value of γ=27 dB for the multi-pass Faraday rotator FIG. 6 with any thermal birefringence of [111] CaF₂ being negligible as per the reference by Snetkov et. al. above. As a cross check on this result, the thermal birefringence of the Faraday optic structure 32 is calculated in accordance with the same equations used for conventional rod shaped geometry in the FIG. 1 thermal birefringence modeling. The average temperature in the TGG Faraday optic 34 along lines on-axis and at the 1/e² radius of a single pass beam was extracted from the finite element temperature model. The difference between the average value along these two lines was taken to represent the average temperature gradient across the beam within the TGG Faraday optic 34. The on-axis average temperature above ambient was found to be 3.933° C. and the average 1/e² temperature was found to be 2.769° C. for an average temperature gradient across the beam of 1.164° C. Finite element analysis was again used to determine what (reduced) TGG absorption coefficient would result in the same average temperature gradient for a TGG rod of radius 2.5 mm and 1.1 cm in length (11 total multi-passes through the TGG faraday optic 34 of the FIG. 6 multi-pass Faraday rotator) when a 0.5 mm radius collimated 1 kW beam 30 is incident upon it. A lower absorption coefficient of 0.082 m⁻¹ was found to give an average temperature gradient or 1.162° C. From eqn. 9, thermal depolarization is then found to be 29 dB—in reasonable agreement with the prior method result of 27 dB. Hence we can predict a useful value of >25 dB isolation at 1 kW for the multi-pass Faraday rotator of FIG. 6 of this invention. Importantly, because heat absorbed in the TGG Faraday optic 34 flows through the CaF₂ windows 33, the negative dn/dT of the CaF₂ windows 33 is able to compensate thermal lensing due to the TGG Faraday optic 34 at all power levels up to the maximum power—and even under dynamically changing power levels.

If reduced thermal birefringence is desired the aspect ratio r₀/h can be increased to scale thermal birefringence proportional to (r₀/h)⁻⁴. The dimensions of the CaF₂ windows 33 can also be tuned to ensure that the compensation of thermal lensing occurring within the TGG Faraday optic 34 is well compensated by the negative dn/dT of the CaF₂ windows 33. If smaller dimensions of the an opposite dn/dT signed heat conductive window such as CaF₂ windows are desired (such as for reducing the size and cost of the magnet structure) an absorbing ion can be doped into CaF₂. This can cause a small absorption which increases the temperature gradient within the CaF₂ such that shorter thicknesses can still fully compensate thermal lensing within the TGG. It is an another aspect of this invention that such absorbing ion(s) doping of CaF₂ may also cause Faraday rotation that is additive to the Faraday optic Faraday rotation, such as doping with terbium or dysprosium ions. Further, the use of negative dn/dT CaF₂ transparent conductive windows 33 in accordance with the invention enables low thermal lens focal shifts and low thermal birefringence with r₀/h aspect ratios that can be lower than those for positive dn/dT transparent conductive windows such as was discussed for FIG. 3a. Because CaF₂ windows 33 combine heat removal from Faraday optics with dn/dT compensation, it can be preferable for some cost/size/simplicity design criteria to also conductively cool the Faraday optic rather than insulating non-optical surfaces as was discussed for FIG. 3a. Because CaF₂ has useable transmission from 0.12 to 7.5 μm, this aspect of the invention can help enable high power UV and mid-IR optical isolators also. In particular, the use of InAs as a broadband Faraday rotator in the 4 to 7 μm spectral range noted previously may benefit from this aspect of the invention.

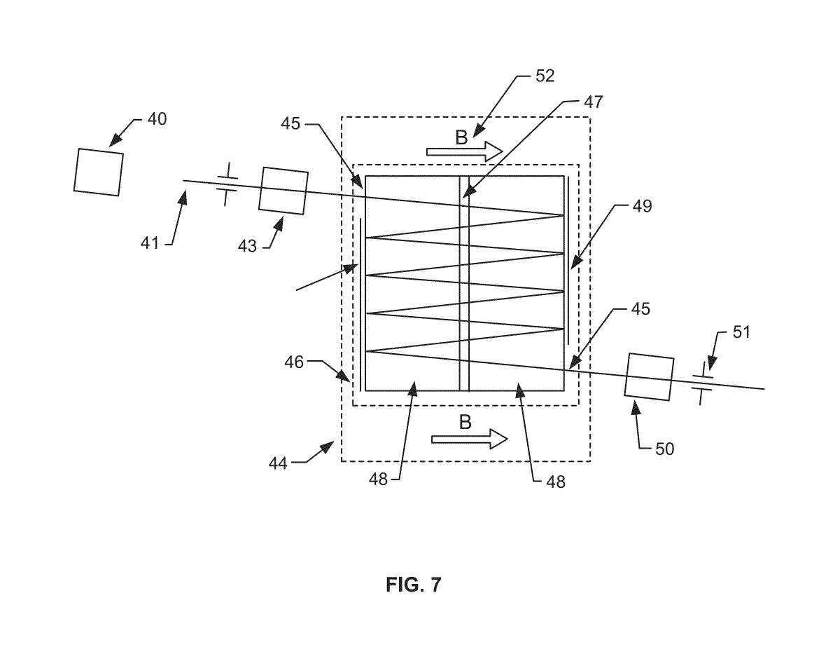

According to yet another aspect of the invention, the high transparency thermally conductive windows may be coated to function as integral fold mirrors in a multi-pass Faraday rotator. FIG. 7 is a schematic plan view of a multi-pass Faraday rotator 44 according to the invention in a 600 W PM multi-pass optical isolator suitable for use with a 970 nm that uses highly transparent, thermally conductive CaF₂ windows 48 as integral fold mirrors bonded to a 1 mm thick TGG Faraday optic 47. In this aspect of the invention, it is desirable to simultaneously lengthen the path-length of the CaF₂ windows 48 while maintaining the magnitude of the oppositely signed phase shifts occurring within them. A longer path-length in the CaF₂ windows 48 is desired so that:
the folded beams within the CaF₂ remain as close as possible to the low thermal birefringence [111] crystal orientation and share a common/symmetric thermal profile;
the refracted beams within the TGG Faraday optic 47 remain parallel to the applied magnetic field;
high reflection (“HR”) mirror coatings 49 applied to the CaF₂ windows have minimal polarization differences (e.g. transmission, phase shift and wavelength discrimination) due to non-normal beam incidence; and
the overall structure including magnets 52 is as compact as possible.

According to the invention, the optical isolator of FIG. 7 uses only 9 passes of a 1 mm thick TGG Faraday optic 47 with an approximately 18.8 kGauss external permanent magnetic field 52 applied due to the higher Verdet constant of the TGG Faraday optic 47 at 970 nm equal to 2.67 deg/(kGauss-cm). 500 W of linearly polarized 970 nm radiation with M²˜13 from a high power laser diode array 40 (Teradiode, Inc., 30 Upton Drive, Wilmington, Mass. 01887) is transmitted through a fused silica polarization beamsplitter cube 43 along axis 41. Highly polarized radiation from input PBS cube 43 is incident upon Faraday optic structure 49 at an external angle of 6.5° into anti-reflection coated transmission window 45. The Faraday optic structure 49 is comprised of CaF₂ windows 48 bonded without adhesive to a TGG Faraday optic 47 such that the two exterior CaF₂ windows 49 optical surfaces are parallel. The [111] crystal orientation of the CaF₂ windows 49 is oriented normal to the CaF₂-TGG optical interface to within 1°. For the reasons stated above the CaF₂ windows 48 used as integral mirrors are 10 mm thick. This gives internal angles in the CaF₂ of 4.6° and 3.4° in the TGG when the ω₀=0.4 mm radius beam is separated from adjacent beams by 4*ω₀ in the TGG. The cross section dimensions of the CaF₂ windows 48 and TGG Faraday optic 47 are the same and equal to 4 mm high and 20 mm wide. In this embodiment all external non-optic surfaces (TGG and CaF₂) are cooled since the −dn/dT of the CaF₂ windows 48 can compensate radial thermal gradients within the TGG Faraday optic 47 as well as remove heat through the TGG faces. As discussed previously, index matching thin film coatings are applied to the optical interface between the CaF₂ windows 48 and the TGG Faraday optic 47 prior to adhesive free bonding. Small anti-reflection coated windows 45 are applied to the opposite ends of the two exterior CaF₂ window 48 optical surfaces to allow for low loss transmission in and out of the multi-pass Faraday optic structure 46. The remainder of the CaF₂ window 48 optical faces are HR coated 49 at 970 nm. They are preferably an alternating high-low refractive index multi-layer thin film coating deposited directly upon the external surface, wherein the first deposition layer onto the external surface of the multi-layer thin film coating is a high index layer with an index of refraction that is greater than the refractive index of the transparent heat conductive layer. It is important that the first layer of the HR thin film coatings 49 applied to the CaF₂ windows 48 have a higher refractive index than CaF₂ (1.429 at 970 nm) in order to maintain a pure it phase shift between orthogonal “s” (sagittal) and “p” (tangential) polarizations due to the non-normal internal 3.4° angle of incidence on these mirrors. In order to better establish an exclusive multi-pass pathway through the Faraday optic structure, scribe lines (not shown) may be optionally etched (for example by a laser ablation or physical scribe before or after coating) between multi-pass beam reflection regions on the integral mirror HR coating 49 to form obscuring apertures that help define the proper reflective beam path. Such optional etched scribe lines could be useful in optical isolator applications were back reflected light into the Faraday optic structure can be off-axis and non-collinear with the forward transmission axis and may also be optionally used with external fold mirrors for previously discussed aspects of the invention. After nine passes through the TGG, the 970 nm exits the Faraday optic structure anti-reflection coated transmission window 45 at an exterior angle of 6.5° where it is incident upon output PBS cube 50 which has its transmission axis rotated 45° with respect to input PBS cube 43. The field strength from magnets 52 is adjusted by physically moving the magnets in relation to the Faraday optic structure 46 such that the polarization rotation from Faraday rotator 44 is precisely 45° at 970 nm.

The Faraday optic structure 46 shown in FIG. 7 was modeled with COMSOL Multi-physics using three 600 W 970 nm laser beams with 0.4 mm real beam radius at the 1/e² intensity level. 600 W was used in the model instead of 500 W to account for an additional 100 W of power back onto the Faraday optic structure from highly reflective targets. Using the same methodology described previously, the phase shifts across the central beam were found extremely low. In the x-axis direction (the plane of the multi-pass beams) the maximum phase shift was 0.02386 rad occurring 0.1 mm from the central beam axis which dropped to 0.02318 rad on axis and 0.00645 rad at 0.4 mm off-axis. This gives a maximum phase difference across the 1/e² radius of 0.017 rad or 0.16 rad=0.025, along the x-axis for 9 passes through the Faraday optic structure. Similarly minimal phase shifts were modeled in the y-axis direction: 0.02318 rad on axis dropping to −0.0256 rad at a radius of 0.4 mm. This results in a maximum phase difference across the 1/e² radius of 0.049 rad or 0.44 rad=0.07λ along the y-axis direction for 9 passes. These phase shifts represent extremely low transmitted wavefront error for such a high power device. Because the TGG non-optical surfaces are also cooled, the theory supporting the premise that thermal depolarization γ is inversely proportional to the fourth power of the aspect ratio r₀/h is not strictly valid. For this reason, thermal birefringence is modeled as a reduced absorption coefficient to cause a similar thermal gradient in a 9 mm long TGG rod of 1.6 mm diameter according the same method used for FIG. 6. The on-axis average temperature in the TGG was only 2.4° C. above ambient. The x-axis average temperature at 0.4 mm off-axis in the TGG was 2.0° C. above ambient for an x-axis average temperature gradient across the beam of 0.4° C. The y-axis average temperature at 0.4 mm off-axis in the TGG was 1.7° C. above ambient for a y-axis average temperature gradient of 0.7° C. across the beam. The TGG absorption coefficient that gives a 0.7° C. (worst case) temperature gradient across the beam is 0.08 m⁻¹, which corresponds to an effective αQ product of (0.08/0.15)×3.7×10₋₇ K⁻¹ m⁻¹=2.0×10⁻⁷ K⁻¹ m⁻¹. For P₀=600 W, αQ=2.0×10⁻⁷ K⁻¹ m⁻¹, 2=970 nm, L=9 mm and K=7.4 W/(m-K), from eqn. 9 we find p=0.15 and γ=0.0003 or 35 dB when H˜0.1 because the 970 nm M²˜13 beam profile is closer to a top hat profile than a Gaussian profile. With negligible thermal lens focal shift and >30 dB predicted isolation, the multi-pass optical isolator of FIG. 7 is a commercially viable example of high transparency thermally conductive windows that are used as integral multi-pass fold mirrors in a high power Faraday rotator.

The transparent heat conductive layer of this aspect of the invention need not be monolithic. This aspect of the invention also contemplates that low or negative dn/dT materials such as fused silica or CaF₂ respectively can be bonded to thin DLC or ta-C films to become a hybrid transparent heat conductive layer that can function as an integral fold mirror according to the invention. Although the HR mirror coatings 49 above were described as thin film coatings, at some wavelength ranges and on some substrates, thin films of metals may also serve as high reflection coatings in accordance with the invention.

In addition to those Faraday optic and transparent heat conductive layer materials listed herein, any appropriate combination of Faraday optic (including but not limited to: diamagnetic, paramagnetic, dilute semiconductor, semiconductor, ferrimagnetic, or ferromagnetic magnetic) and transparent heat conductive layers may be used to form a Faraday optic structure for use in a multi-pass Faraday rotator in accordance with the invention.

The detailed description of the drawings above have described 45 degree Faraday rotators required by typical Faraday effect devices in accordance with the invention. Faraday rotation values other than 45 degrees are sometimes required and can be constructed in accordance with the present invention. For example, ≦10° of Faraday rotation is often to force unidirectional lasing within cw ring laser cavities to obtain stable single frequency emission. Further, the previously cited paper by I. Mukhin and E. Khazanov, “Use of thin discs in Faraday isolators for high-average-power lasers,” Quantum Electronics 34(10) 973-978 (2004), describes the use of two helium face cooled 22.5° thin disc Faraday rotators in conjunction with a reciprocal optical rotation element between them. The authors show how this can largely cancel the thermal birefringence occurring in the first 22.5° thin disc Faraday rotator by the thermal birefringence in the second 22.5° thin disc Faraday rotator with this method. Although the specific embodiments discussed above have used circular cross section beams for clarity, any beam shape (elliptical, rectangular, square, etc.) and beam intensity profile (Gaussian, top-hat, donut etc. . . . ) can be used with the multi-pass Faraday rotators of this invention. Therefore it is not intended that this invention be limited, except as indicated by the appended claims.

What is claimed is:

1. A multi-pass Faraday rotator for a laser beam at a selected wavelength comprising:
a Faraday optic with opposing optical faces through which there is a beam propagation axis;
first and second transparent heat conductive layers, said transparent heat conductive layers being bonded to the opposing optical faces of said Faraday optic to form a Faraday optic structure;
beam folding mirrors to form a multi-pass path of at least two passes through said Faraday optic structure; and
a source for an external magnetic field that is substantially parallel with the beam propagation axis for each pass through said Faraday optic structure, the magnetic field being of sufficient strength to induce a desired Faraday rotation in said multi-pass Faraday rotator;
said transparent heat conductive layers having sufficient thermal conductivity to conduct heat through the Faraday optic substantially parallel to the beam propagation axis for each pass through the Faraday optic structure and thereby reducing thermal gradients across the beam cross section that would otherwise contribute to thermal lens focal shifts and thermal birefringence in the Faraday optic structure.

2. The multi-pass Faraday rotator of claim 1 where refractive index matching coating layers are deposited on said Faraday optic and/or said transparent heat conductive layers prior to forming said Faraday optic structure for at least the purposes of reducing reflections within said Faraday optic structure.

3. The multi-pass Faraday rotator of claim 1 where said transparent heat conductive layers are windows that are anti-reflection coated on their non-bonded optical surface.

4. The multi-pass Faraday rotator of claim 3 where said windows are selected from the group consisting of synthetic diamond, undoped YAG, undoped silicon, germanium and c-axis sapphire.

5. The multi-pass Faraday rotator of claim 1 wherein said transparent heat conductive layers are formed of at least one hydrogenated “diamond-like” carbon [“DLC”] or non-hydrogenated tetrahedral carbon [“ta-C”] films deposited directly onto said Faraday optic or onto index matching layers on said Faraday optic.

6. The multi-pass Faraday rotator of claim 5 wherein said films have a thickness that is a low integer multiple of the laser wavelength plus one-quarter wavelength in order to function as anti-reflection coatings.

7. The multi-pass Faraday rotator of claim 1 where at least one of said transparent heat conductive layers has a dn/dT coefficient that is of opposite sign to the said Faraday optic.

8. The multi-pass Faraday rotator of claim 7 where said dn/dT coefficient transparent heat conductive layer of opposite sign is a fluoride crystal such as CaF₂.

9. The multi-pass Faraday rotator of claim 1 wherein said transparent heat conductive window is a substrate and said Faraday optic is disposed directly on said substrate.

10. The multi-pass Faraday rotator of claim 9 wherein said transparent heat conductive window substrate and/or said Faraday optic are transparent ceramics and said direct disposition is by a final sintering process.

11. The multi-pass Faraday rotator of claim 1 wherein at least one said beam folding mirrors is a highly reflective coating applied to at least a portion of the external surface of one or both of said transparent heat conductive layers to establish said multi-pass path.

12. The multi-pass Faraday rotator of claim 11 wherein said highly reflective coating comprises alternating high-low refractive index multi-layer thin film coatings deposited directly upon said external surface, wherein a first deposition layer onto the external surface of said multi-layer thin film coating is a high index layer with an index of refraction that is greater than the refractive index of said transparent heat conductive layer.

13. The multi-pass Faraday rotator of claim 1 wherein obscuring apertures are scribed or etched onto the external surfaces of said transparent heat conductive layers to define a specific multi-pass path.

14. The multi-pass Faraday rotator of claim 7 where said opposite sign transparent heat conductive layers is doped with an absorbing ion.

15. The multi-pass Faraday rotator of claim 14 where said absorbing ion contributes Faraday rotation which is additive to said Faraday optic Faraday rotation.
